(19) United States
(12) Patent Application Publication
(10) Pub. No.: US 2020/0086810 A1
(43) Pub. Date: Mar. 19, 2020

(54) INVISI-PLATE

(71) Applicant: Jermaine Smith, Irving, TX (US)

(72) Inventor: Jermaine Smith, Irving, TX (US)

(21) Appl. No.: 16/568,360

(22) Filed: Sep. 12, 2019

Related U.S. Application Data
(60) Provisional application No. 62/730,606, filed on Sep. 13, 2018.

(51) Int. Cl. B60R 13/10; B60Q 1/56

(52) U.S. Cl. CPC B60R 13/105; G09F 2007/1895; B60Q 1/56

(57) ABSTRACT

A license plate holder is implemented which displays a license plate from inside of a vehicle while positioned on the inside dashboard. The license plate holder comprises a base, a receiving portion, and a slot on the receiving portion into which the license plate is inserted. The receiving portion may be attached to the base using a hinge that can lock in multiple positions. The base of the holder further includes a light bar with one or more LEDs (light emitting diodes) and a switching panel. The light bar can illuminate the license plate and improve visibility at night time. The one or more LEDs are powered by a power source, such as batteries, which are disposed within the base of the license plate holder. The user can activate and deactivate the light bar in different colors using the switching panel.

### BACKGROUND

It is often required by law for license plates to be visible at all times on a front and rear of a vehicle (e.g., automobiles, trucks, SUVs (Service Utility Vehicles) etc.). License plates are functional components that enable identification of the specific vehicle within a state or other geographical area. Placing the license plate on the front windshield inside the car can at times pose visibility issues. While adhesive or other fastening mechanisms may be utilized to stick the license plate to the inside windshield, this can reduce aesthetics of the vehicle or be affected by vehicle movements, vibrations, etc.

### SUMMARY

A license plate holder is implemented that enables a user to display the license plate from inside the vehicle. The license plate holder includes a base which rests on a dashboard of the vehicle and a receiving portion which includes a slot into which the license plate is inserted. A bottom surface of the base can include a foam-like material to prevent movement of the license plate holder while the vehicle is in motion, and the slots can likewise include a resistance-type material, like foam or rubber, to secure the license plate in place. The receiving portion moves about a hinge on the base to enable adjustment of the license plate in multiple locations to accommodate different vehicle windshields. One or more LEDs (light emitting diodes) may also be implemented on the license plate holder, such as on the base, to illuminate the license plate, such as at night. The LEDs may be controllable via an on/off switch which can also control what color light is switched on (e.g., red, green, blue, or white).

### BRIEF DESCRIPTION OF THE DRAWINGS

FIG. 1 shows a perspective view of a license plate holder positioned in front of a windshield of a vehicle;

FIG. 2A shows an exploded view of a license plate holder and a license plate;

FIG. 2B shows a perspective view of a license plate holder securing or holding a license plate;

FIG. 2C shows a perspective view of a license plate holder with multiple supports to the holder;

FIG. 3A shows a side view of a license holder;

FIG. 3B shows a front exploded view of a license plate holder;

FIG. 4 shows a front view of a light bar of the license plate holder; and

FIG. 5 shows a front view of a switching panel of the license plate holder.

Like reference numerals indicate like elements in the drawings. Elements are not drawn to scale unless otherwise indicated.

### DETAILED DESCRIPTION

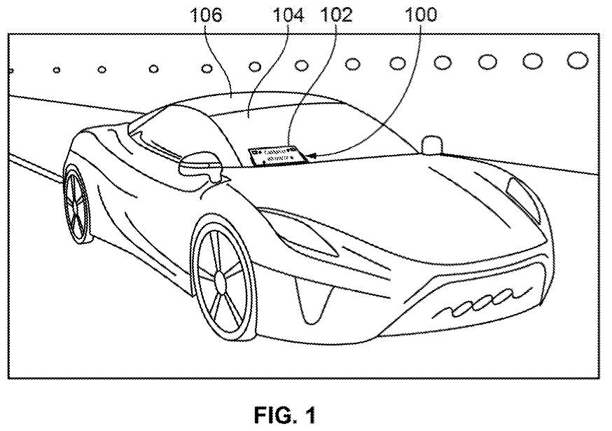

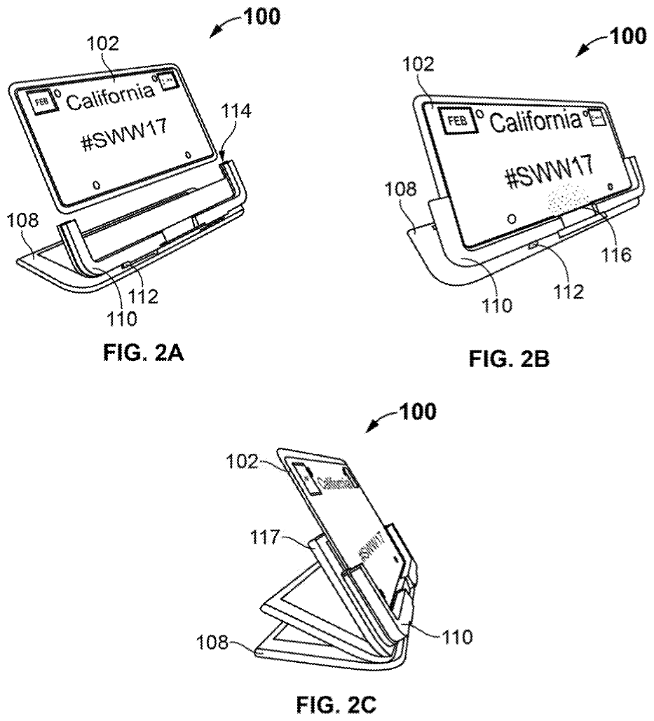

FIG. 1 shows a license plate holder 100 positioned inside the car at the windshield 104 of a vehicle 106. The license plate holder 100 could be positioned upon a user's dashboard and holds the license plate 102 at the same angle as the windshield 104. The license plate holder 100 could be designed to display the front of the license plate 102 to meet local and state requirements while maintaining the aesthetics of the vehicle 106. The license plate holder 100 rests upon a dashboard of the vehicle 106 via a non-slip foam on a base 108 (shown in FIG. 2A), that prevents it from sliding on the dashboard. The license plate holder 100 holds the license plate 102 firmly and effectively displays the license plate 102. In one embodiment, the license plate 102 could be a number plate or a vehicle registration plate, which is a metal or plastic plate attached to the vehicle 106 or trailer for official identification purposes.

FIG. 2A shows the license plate 102 lined up with a slot 114 on a receiving portion 110 of the license plate holder 100. The holder 100 includes a base 108 which rests on the dashboard to prevent movement of the holder. For example, the base 108 may be coated with a non-slip foam such as ethylene-vinyl acetate (EVA). The EVA foam may be bonded to the lower section of the base 108 via an adhesive. The base 108 is configured to provide support to the receiving portion 110 and the license plate 102 when placed within the vehicle, while also preventing movements of the license plate holder 100 on the dashboard of the vehicle 106 while traveling.

The receiving portion 110 includes opposing arms with respective slots which may be lined with foam to securely hold the license plate 102 during use. The opposing arms, for example, can accommodate opposing ends of the license plate when inserted into the receiving portion. The receiving portion 110 can be attached to the base 108 via a hinge 112. The slot of the receiving portion 110 receives the license plate 102 and thereby secures the license plate 102 to the holder 100. The receiving portion 110 is connected to the base via a hinge 112 which has multiple positions at which it can secure to accommodate different angled windshields. The friction between the base and the receiving portion is sufficient between the hinge segments to clamp the receiving portion 110 and the license plate 102 at the proper angle until intentionally moved by the user.

In some embodiments, the license plate holder 100 may be injection molded and comprised of any one or more of plastic, ABS polycarbonate, rubber, metal, etc. For example, the ABS polycarbonate plastic may be used for making the license plate holder 100, which is durable, resistant to drop shocks, automotive chemicals and UV degradation. The molded plastic components may have UV protectants that are resistant to UV degradation given the high degree of sun exposure on the vehicle dashboard.

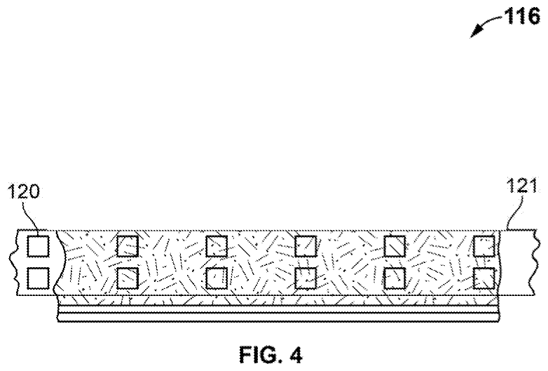

The base 108 comprises a light bar 116 as shown in FIG. 2B. The light bar 116 may be positioned within the base 108 to project light upward through a diffusing plastic lens or a protective lens 121 (shown in FIG. 4). The light bar 116 is configured to illuminate the license plate 102 and improve the visibility of the license plate 102 at night or dark time. In some embodiments, the light bar 116 could be a LED light strip, and a LED light bar.

FIG. 2C shows a license plate holder 100 with multiple positions 117 at which the license plate can be oriented inside the holder. FIG. 2C represents a single receiving portion 110 on the holder having multiple different positions at which the receiving portion can be oriented, and does not show multiple different receiving portions 117 used within the holder. The multiple of positions 117 are configured to provide support to the receiving portion 110 of the license plate holder 100.

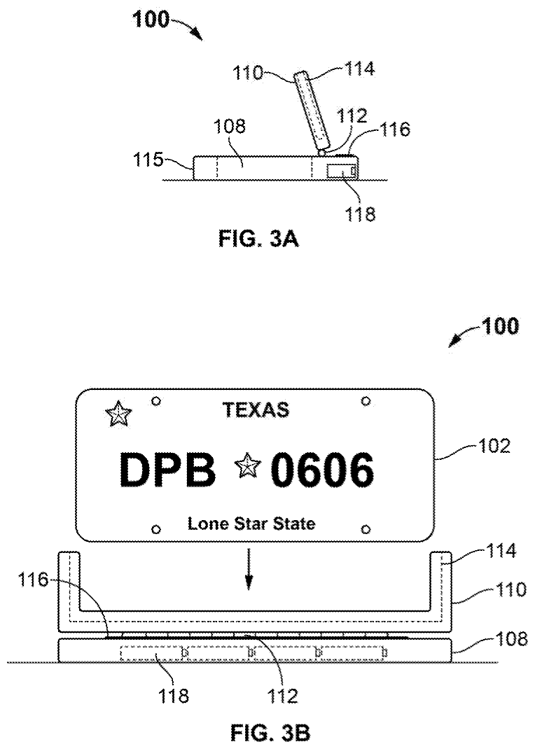

FIGS. 3A and 3B show the license plate holder 100, in which the base 108 includes a switching panel 115 and a plurality of power sources 118 (e.g., a battery, rechargeable battery, etc.) which provides power to the light bar 116. The plurality of power sources 118 (e.g., batteries) may be disposed within the base 108 of the license plate holder 100. The plurality of power sources 118 could be an alkaline, a rechargeable alkaline, NiZN, NiMH, NiCD, a lithium battery, and a fuel cell battery. The license plate holder 100 may be powered with four batteries and has an operating life of approximately 50 hours per one set of batteries. The license plate holder 100 could be used for license plate 102 having standard dimensions as used in various states in the United States, but other dimensions are also possible to accommodate other countries' laws.

In other embodiments, the license plate holder 100 may be powered with internally mounted rechargeable batteries and has an on-board charger. In one embodiment, the charger converts 12V DC vehicular power to the required DC power for operating the license plate holder 100 via a power cord. The power cord has may have vehicular power port plug and a USB connector to connect to the license plate holder 100.

FIG. 4 illustratively shows the light bar 116 on the license plate holder 100, in which the light bar 116 includes a plurality of LEDs 120 having one or multiple different colors for lighting the holder. While multiple LEDs are depicted, in other implementations, a single LED may be utilized. The LEDs 120 may be mounted on a flexible printed circuit board (PCB) via an adhesive which is powered via the power source 118.

The plurality of LEDs 120 may different colors, such as red, green, blue and white. The light bar 116 may be covered with a diffusing plastic lens 121 to project or emit the light uniformly onto the license plate 102 (shown in FIG. 3B). The diffusing plastic lens 121 may protect the plurality of LEDs 120 from physical damage. The plurality of LEDs 120 are mounted on a flexible circuit board to receive power from the power source and thereby emit light.

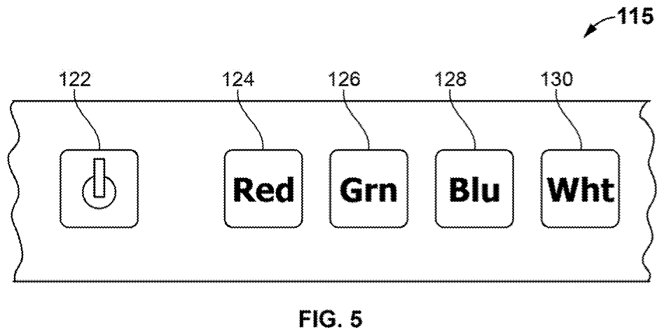

FIG. 5 shows the front view of a switching panel 115 which operates as an input mechanism for the license plate holder 100, in which the switching panel 115 is disposed on the surface of the base 108. The switching panel 115 includes a plurality of tactile membrane buttons or switches 122, 124, 126, 128 and 130 for activating the power and illuminate the light bar 116 in different colors. The user could switch ON or OFF the light bar 116 via the power switch 122. The user can press the switch 124 for illuminating the light bar 116 in red color. When the light bar is switched on, then the user can press the various buttons to illuminate the light bar the corresponding color, such as red, green, blue, or white. Multiple lights can be switched on simultaneously as well.

The tactile membrane switches 122, 124, 126, 128 and 130 may be sealed and resistant to finger oils, household, and vehicle cleaning chemicals. The user could select and illuminate the light bar in any different color via any one of the four switches 124, 126, 128 and 130 one or multiple colors could be selected for use at a time. In some embodiments, the lightbar can be configured to only enable one color light at a given time, such as by preventing multiple buttons from being simultaneously selected, or causing one button to switch off when another color button is selected. In other embodiments, however, multiple lights can be selected at a single time. While the switching panel is disclosed above, other input mechanisms area also possible, including touch-based display screen operatively connected to the license plate holder, or other input mechanism.

In some implementations, the PCB may likewise include a processor, such as a microcontroller, to control the functions of the PCB, such as switch the lights on and off responsive to user input. Memory, such as flash memory, read-only memory (ROM), random access memory (RAM), etc. can likewise be utilized with the processor to enable control over the LEDs. For example, the memory may store instructions as to which color light to switch on responsive to the user's input at the input mechanism.

The plurality of LEDs 120 and the circuit connections are made on a printed circuit board (PCB). The standard thickness, double sided FR4 circuit board material is populated with surface mounted components where possible. Any through-hole devices are inserted after the surface mounted assembly, soldering, and cleaning. Both circuit boards are designed to have all the components oriented so they could be mounted with the LED illuminators projecting upward out of the lenses mounted in the housings. After assembly, the PCBs are protected with a moisture adsorption preventive conformal coating.

The license plate holder 100 is designed to be aesthetic and effective in the application. The license plate holder 100 will allow the user to display the license plate 102 (shown in FIG. 1) from inside the vehicle 106 (shown in FIG. 1) without bolting or fastening or alterations to the front of the vehicle 106 (shown in FIG. 1). The relative ease of manufacture and the moderately inexpensive components provide good marketability for the manufacturer. The user benefits from improved visibility of the license plate 102 (shown in FIG. 1) while preserving the aesthetics of the vehicle design provides market interest in the cost-effective product.

Exemplary embodiments are present in the disclosure. For example, disclosed is a license plate holder, comprising: a base; a hinge connected to the base; and a receiving portion at least indirectly connected to the base and which moves about the hinge, in which the receiving portion extends upward from the base and includes one or more arms, the one or more arms include a slot that is configured to receive a license plate.

In another example, the receiving portion includes two opposing arms that each respectively include a corresponding slot to receive opposing ends of the license plate. As another example, the slot on the one or more arms includes a material to secure the license plate into the receiving portion. In another example, the material includes foam. In another example, the material includes rubber. As another example, the hinge moves and locks the receiving portion into multiple positions about the hinge. As another example, the hinge locks in place using friction fit or a tab and notch mechanism. As another example, a non-slip material is attached to a bottom surface of the base to prevent movement when the license plate holder is in use. As another example, the non-slip material is foam. In another example, the license plate holder includes one or more LEDs (light emitting diodes) attached to the base and which lighten the license plate. In another example, the license plate holder includes an switch to turn the one or more LEDs on and off. As another example, multiple LEDs comprised of differing colors are implemented. As another example, the license plate holder further includes an input mechanism to enable a user to select which color LED is switched on. As another example, the input mechanism is configured to enable only a single color LED light to be switched on at a time. In another example, the license plate holder includes a printed circuit board (PCB) on which the one or more LEDs are positioned; and a power source operatively coupled to the PCB to provide power to the one or more LEDs when switched on.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims

1. A license plate holder, comprising:
a base;
a hinge connected to the base; and
a receiving portion at least indirectly connected to the base and which moves about the hinge, in which the receiving portion extends upward from the base and includes one or more arms, the one or more arms include a slot that is configured to receive a license plate.

2. The license plate holder of claim 1, in which the receiving portion includes two opposing arms that each respectively include a corresponding slot to receive opposing ends of the license plate.

3. The license plate holder of claim 1, in which the slot on the one or more arms includes a material to secure the license plate into the receiving portion.

4. The license plate holder of claim 3, in which the material includes foam.

5. The license plate holder of claim 3, in which the material includes rubber.

6. The license plate holder of claim 1, in which the hinge moves and locks the receiving portion into multiple positions about the hinge.

7. The license plate holder of claim 6, in which the hinge locks in place using friction fit or a tab and notch mechanism.

8. The license plate holder of claim 1, in which a non-slip material is attached to a bottom surface of the base to prevent movement when the license plate holder is in use.

9. The license plate holder of claim 6, in which the non-slip material is foam.

10. The license plate holder of claim 1, further comprising one or more LEDs (light emitting diodes) attached to the base and which lighten the license plate.

11. The license plate holder of claim 10, further comprising a switch to turn the one or more LEDs on and off.

12. The license plate holder of claim 10, in which multiple LEDs comprised of differing colors are implemented.

13. The license plate holder of claim 12, further comprising an input mechanism to enable a user to select which color LED is switched on.

14. The license plate holder of claim 13, in which the input mechanism is configured to enable only a single color LED light to be switched on at a time.

15. The license plate holder of claim 10, further comprising:
a printed circuit board (PCB) on which the one or more LEDs are positioned; and
a power source operatively coupled to the PCB to provide power to the one or more LEDs when switched on.
